(19) United States
(12) Patent Application Publication
(10) Pub. No.: US 2024/0393487 A1
(43) Pub. Date: Nov. 28, 2024

(54) METHODS AND SYSTEMS FOR DETERMINING A GEOLOGICAL MODEL USING NORMALIZED WEIGHTS

(71) Applicant: SAUDI ARABIAN OIL COMPANY, Dhahran (SA)

(72) Inventor: Hussain A. Al Khalifah, Dammam (SA)

(73) Assignee: SAUDI ARABIAN OIL COMPANY, Dhahran (SA)

(21) Appl. No.: 18/324,855

(22) Filed: May 26, 2023

(51) Int. Cl. G01V 1/28; G01V 1/30; G01V 1/50

(52) U.S. Cl. CPC G01V 1/282; G01V 1/303; G01V 1/50; G01V 2210/6222

(57) ABSTRACT

Methods and systems are disclosed. The methods may include obtaining a measured value of a geological parameter from each of multiple positions within a subterranean region of interest and, for each position within the multiple positions in turn, assigning each position as a current position and determining a weight for the current position, based on a distance from the current position to each of the multiple positions. The methods may further include determining a normalization factor that includes a sum of the determined weights and determining, by applying the normalization factor, a normalized weight for each of the determined weights. The methods may still further include determining a geological model, that represents the subterranean region of interest, based on the obtained measured values and the determined normalized weights.

### BACKGROUND

A subterranean region of interest may be vast and complex. As such, accurate characterization of the subterranean region of interest may be challenging. Albeit challenging, characterization may be valuable as the subterranean region of interest may contain economically useful features, such as water and hydrocarbon reservoirs and mines. As economically useful features are identified within a subterranean region of interest, wells may be drilled or tunnels dug to access those features and recover the contents of those features to the surface for use. A seismic data may be collected prior to, during, and/or following the drilling of a well or digging of a tunnel to characterize discrete positions within the subterranean region of interest. Further, well logs and/or rock cores may alternatively or additionally be collected during and/or following the drilling of the well or digging of the tunnel to characterize other discrete positions or further characterize the discrete positions within the subterranean region of interest. Over time, seismic data, well logs, and/or rock cores may be used to characterize positions densely clustered around useful features leaving positions between useful features largely uncharacterized.

Gridding algorithms may be used to characterize the subterranean region of interest at uncharacterized positions using interpolation methods. Some gridding algorithms may rely on a weighting scheme that assigns a weight to each characterized position prior to interpolation without considering the density of the characterized positions. Such weighting schemes may lead to erroneous characterization of the subterranean region of interest at each uncharacterized position by biasing the characterization towards densely-positioned, characterized positions even if the features at the densely-positioned, characterized positions are dissimilar to the uncharacterized position.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining a measured value of a geological parameter from each of multiple positions within a subterranean region of interest and, for each position within the multiple positions in turn, assigning each position as a current position and determining a weight for the current position, based on a distance from the current position to each of the multiple positions. The method further includes determining a normalization factor that includes a sum of the determined weights and determining, by applying the normalization factor, a normalized weight for each of the determined weights. The method still further includes determining a geological model, that represents the subterranean region of interest, based on the obtained measured values and the determined normalized weights.

In general, in one aspect, embodiments relate to a non-transitory computer-readable memory storing instructions that perform steps executable by a computer processor. The steps include receiving a measured value of a geological parameter from each of multiple positions within a subterranean region of interest and, for each position within the multiple positions in turn, assigning each position as a current position and determining a weight for the current position, based on a distance from the current position to each of the multiple positions. The steps further include determining a normalization factor that includes a sum of the determined weights and determining, by applying the normalization factor, a normalized weight for each of the determined weights. The steps still further include determining a geological model, that represents the subterranean region of interest, based on the received measured values and the determined normalized weights.

In general, in one aspect, embodiments relate to a system. The system includes an analysis tool configured to determine a measured value of a geological parameter from each of multiple positions within a subterranean region of interest. The system further includes a computer system configured to receive the measured value from the analysis tool and, for each position within the multiple positions in turn, assign each position as a current position and determine a weight for the current position, based on a distance from the current position to each of the multiple positions. The computer system is further configured to determine a normalization factor that includes a sum of the determined weights and determine, by applying the normalization factor, a normalized weight for each of the determined weights. The computer system is still further configured to determine a geological model, that represents the subterranean region of interest, based on the received measured values and the determined normalized weights.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a subterranean region of interest in accordance with one or more embodiments.

FIG. 2 illustrates a drilling system in accordance with one or more embodiments.

FIG. 3 illustrates a core plug analysis tool in accordance with one or more embodiments.

FIG. 4 illustrates a geological model in accordance with one or more embodiments.

FIG. 5 shows a flowchart in accordance with one or more embodiments.

FIG. 6 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a geological parameter” includes reference to one or more of such parameters.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

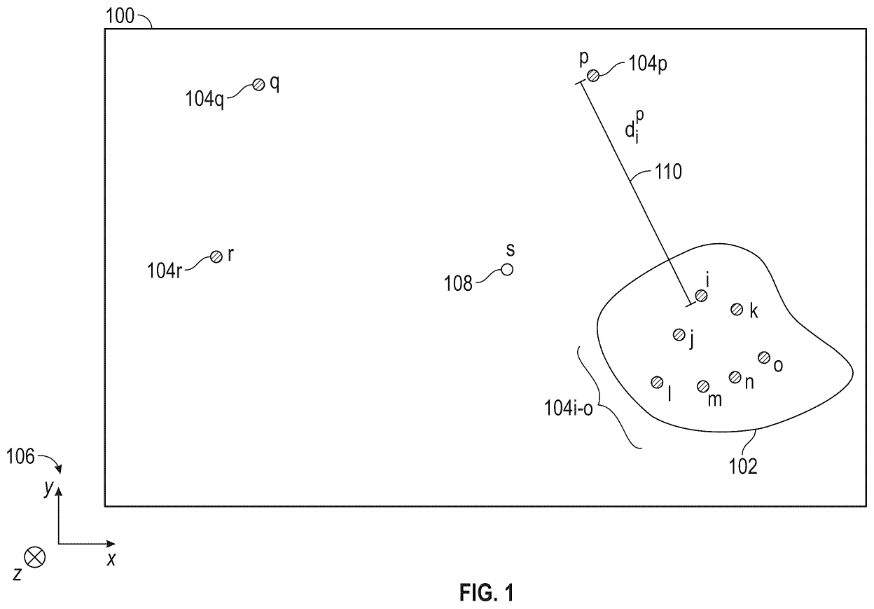

In the following description of FIGS. 1-6, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods are disclosed that describe a weighting scheme that assigns a large weight to each characterized position that is a distant neighbor of other sparsely-positioned, characterized positions and a small weight to each characterized position that is a close neighbor to other densely-positioned, characterized positions. The weighting scheme may be used within a gridding algorithm to characterize a subterranean region of interest at uncharacterized positions in the form of a geological model.

Turning to FIG. 1, FIG. 1 illustrates a top-down view of a subterranean region of interest (100) in accordance with one or more embodiments. The subterranean region of interest (100) may include economically useful features, such as a water or hydrocarbon reservoir (102). The subterranean region of interest (100) may also include a plurality of discrete positions, such as discrete positions (104i-r), that have been previously characterized. Note that while FIG. 1 only shows one position (104i-r) at an x-y location, multiple positions (104i-r) may exist at the same x-y location but at different depths or z locations as designated by the coordinate system (106).

Some positions (104i-r) within the subterranean region of interest (100) may be densely clustered around a useful feature. For example, FIG. 1 shows positions i-o (104i-o) densely clustered around the reservoir (102). Other positions (104i-r) within the subterranean region of interest (100) may be distantly spaced. For example, FIG. 1 shows positions p-r (104p-r) distantly spaced from any other position (104i-r) within the subterranean region of interest (100). Hereinafter, positions i-o (104i-o) may be referred to as “densely-positioned” positions due to the proximity of each position relative to other positions. Further hereinafter, positions p-r (104p-r) may be referred to as “sparsely-positioned” positions.

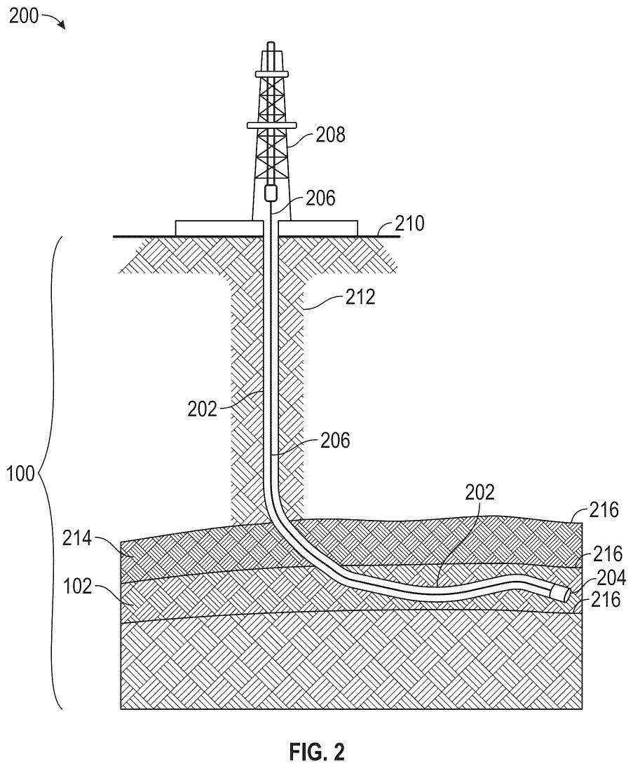

In some embodiments, a well has been drilled using a drilling system at one or more positions (104i-r) within the subterranean region of interest (100). FIG. 2 illustrates a drilling system (200) in accordance with one or more embodiments. A well (202) may be drilled within a subterranean region of interest (100) using a drill bit (204) attached to a drillstring (206) further attached to a drill rig (208), where the drill rig (208) is located on the surface of the earth (210). The well (202) may traverse a plurality of overburden layers (212), one or more cap-rock layers (214), and geological discontinuities (216) to reach a reservoir (102). Well logs may be collected during and/or following drilling using a well logging tool. Well logging tools may include, but are not limited to, measurements-while-drilling tools, logging-while-drilling tools, and wireline logging tools. Rock cores may be collected during drilling using a well coring system. The well coring system may be integrated into the drilling system (200).

Wells (202) drilled at densely-positioned positions (104i-o), as shown in FIG. 1, may penetrate a reservoir (102) and recover fluids from the reservoir (102). Wells (202) drilled at sparsely-positioned positions (104p-r), as shown in FIG. 1, may or may not penetrate a useful feature.

Well logs, rock cores, and/or seismic data associated to a position (104i-r) may be used to characterize that position (104i-r). Note that seismic data may be collected from a seismic survey, such as a surface seismic survey of the subterranean region of interest (100) or a vertical seismic profile (VSP) survey surrounding the well (202) within the subterranean region of interest (100). Each position (104i-r) may be characterized by determining a measured value of a geological parameter. The geological parameter may include, but is not limited to, seismic velocity, resistivity, porosity, permeability, density, feature thickness, or any combination thereof.

An analysis tool may be configured to determine a measured value of a geological parameter from one or more positions (104i-r). The analysis tool may be, but is not limited to, a core plug analysis tool (e.g., permeability system), well logging tool, or seismic survey analysis tool (i.e., a seismic acquisition system). However, a person of ordinary skill in the art will appreciate that the analysis tool used to characterize one position (104i-r) need not be the analysis tool used to characterize another position (104i-r).

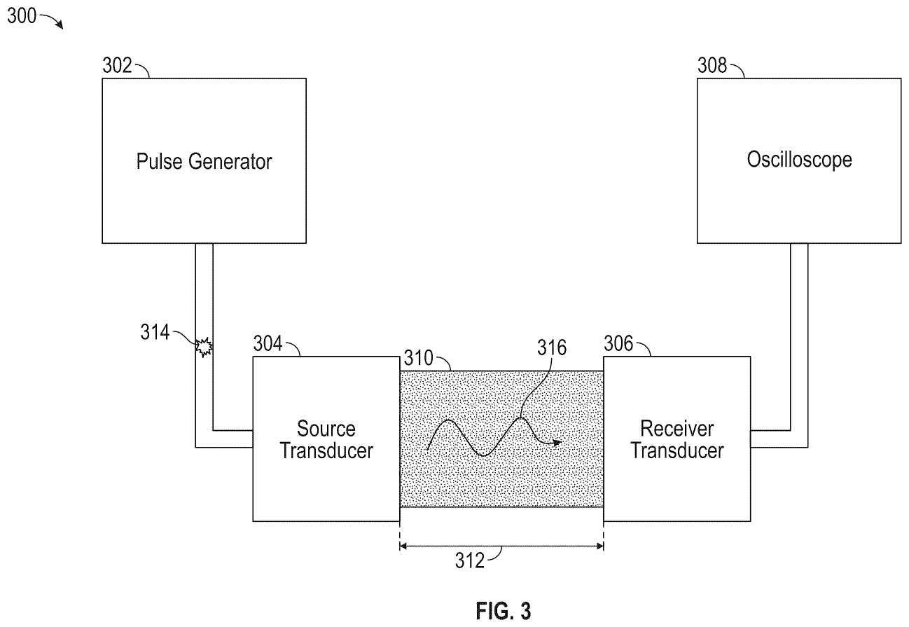

In some embodiments, for example, a core plug analysis tool may be used to determine a measured value of seismic velocity from a core plug (310) using a source transducer-receiver transducer pair. FIG. 3 illustrates a core plug analysis tool (300) in accordance with one or more embodiments. The core plug analysis tool (300) may include a pulse generator (302), a source transducer (304), a receiver transducer (306), and an oscilloscope (308), among other components. The source transducer (304) and receiver transducer (306) may each be a piezometric transducer. Prior to testing, a rock core collected from the subterranean region of interest (100) may be cut and ground into core plugs (310). A core plug (310) of known length (312) may be placed between the source transducer (304) and the receiver transducer (306) of the core plug analysis tool (300) prior to testing. During testing, the pulse generator (302) may emit a short pulse of current (314) (hereinafter “pulse”) that travels to the source transducer (304). In turn, the source transducer (304) converts the pulse (314) to seismic waves (316) that propagate through the core plug (310). The seismic waves (316) are received by the receiver transducer (306) that converts the seismic waves (316) back into a pulse (314). The pulse (314) may be received by an oscilloscope (308). The time it takes for the seismic waves (316) to travel through the core plug (310), along with the length (312) of the core plug (310), may then be used to determine seismic velocity.

In some embodiments, testing may be repeated for a core plug (310) collected from each of different positions (104i-r) within the subterranean region of interest (100) to characterize each of the different positions (104i-r) using a measured value of seismic velocity. In other embodiments, well logs may be interpreted to characterize additional positions (104i-r) within the subterranean region of interest (100) using a measured value of seismic velocity or other geological parameter. In still other embodiments, seismic data may be processed and used to characterize additional positions (104i-r) within the subterranean region of interest (100). A person of ordinary skill in the art will also appreciate that any combination of these methods may be used to characterize each position (104i-r) within the subterranean region of interest (100) using a measured value of a geological parameter without departing from the scope of the disclosure. Hereinafter, each previously characterized position (104i-r) may simply be referred to as a “position.”

While characterization of positions (104i-r) within the subterranean region of interest (100) may be useful, it may be challenging to characterize the entire subterranean region of interest (100) due to how vast and complex the subterranean region of interest (100) may be. As such, it may be useful to determine estimated values of the geological parameter between positions (104i-r) to characterize more or all of the subterranean region of interest (100).

In some embodiments, estimated values of the geological parameter between characterized positions (104i-r) may be determined using a gridding algorithm. A gridding algorithm may also be known as an interpolation algorithm. Gridding algorithms include, but are not limited to, linear interpolation, polynomial interpolation, bilinear interpolation, spline interpolation, natural neighbor interpolation, inverse distance weighting interpolation, minimum curvature interpolation, and kriging.

Some gridding algorithms may rely on a weighting scheme. A weighting scheme may assign a weight to each characterized position (104i-r) within the subterranean region of interest (100). In turn, the weight assigned to each position (104i-r) may be used during interpolation to determine the estimated values of the geological parameter between positions (104i-r).

Common weighting schemes may assign a weight to each position (104i-r) without considering the density of the positions (104i-r). However, it may be disadvantageous to not consider the density of the positions (104i-r) as to not consider the density may lead to biased estimated values of the geological parameter towards densely-positioned, characterized positions (104i-o). For example, returning to FIG. 1, assume a value of the geological parameter at a new position s (108) is unknown. Further, assume the features at the new position s (108) are similar to the features at the sparsely-positioned, characterized positions p-r (104p-r) and dissimilar to the features at the densely-positioned, characterized positions i-o (104i-o). If a common weighting scheme is used within a gridding algorithm, the estimated value of the geological parameter at the new position s (108) may be biased or skewed towards the measured values at the densely-positioned, characterized positions i-o (104i-o) though the features at new position s (108) may be more similar to the features at the sparsely-positioned, characterized positions p-r (104p-r).

To overcome biased estimated values of the geological parameter between positions (104i-r), this disclosure details an alternative weighting scheme based on distance. In some embodiments, distance may be a horizontal distance (110) as shown in FIG. 1. In other embodiments, distance may be a three-dimensional distance that also considers depth. In still other embodiments, distance may be a polynomial of distance, such as the square of a distance.

The alternative weighting scheme may assign a large weight to each sparsely-positioned position (104p-r) and a small weight to each densely-positioned position (104i-o). For example, the alternative weighting scheme may assign a similar large weight to each of positions p-r (104p-r). Further, the alternative weighting scheme may assign a small weight to each of positions i-o (104i-o) such that the sum of these weights is similar to each weight assigned to each of positions p-r (104p-r). Thus, position p (104p), position q (104q), position r (104r), and the group of positions i-o (104i-o) may each be similarly weighted. In turn, the estimated value of the geological parameter at new position s (108) may be similarly affected by the measured value(s) of the geological parameter at position p (104p), position q (104q), position r (104r), and the group of positions i-o (104i-o).

Following the use of the alternative weighting scheme to assign a weight to each position (104i-r), in some embodiments, a gridding algorithm may be used, along with the measured value of the geological parameter at each position (104i-r), to determine estimated values of the geological parameter between positions (104i-r). The estimated values and measured values of the geological parameter may be described collectively as a geological model.

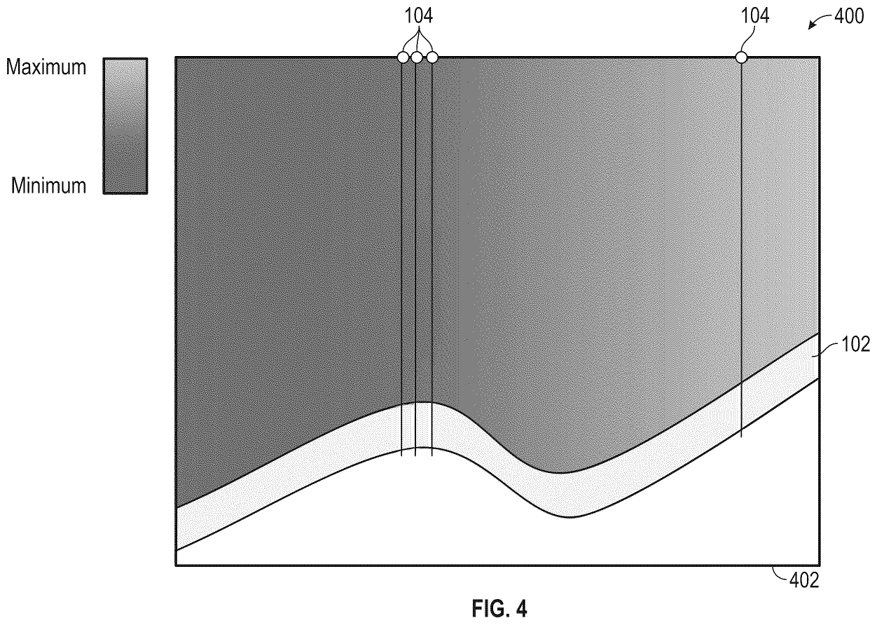

FIG. 4 illustrates a geological model (400) in accordance with one or more embodiments. The geological model (400) is a representation of the subterranean region of interest (402) that includes a reservoir (102). While FIG. 4 illustrates a geological model (400) with two spatial dimensions, the geological model (400) may be any dimensionality, which may include time, without departing from the scope of the disclosure. As noted previously, the geological model (400) may characterize more or all of the subterranean region of interest (100) using both the measured values of the geological parameter determined at discrete positions (104) and estimated values of the geological parameter at new positions (i.e., all remaining positions that are not positions (104) as shown in FIG. 4) where the scale bar provides a range of estimated values of the geological parameter.

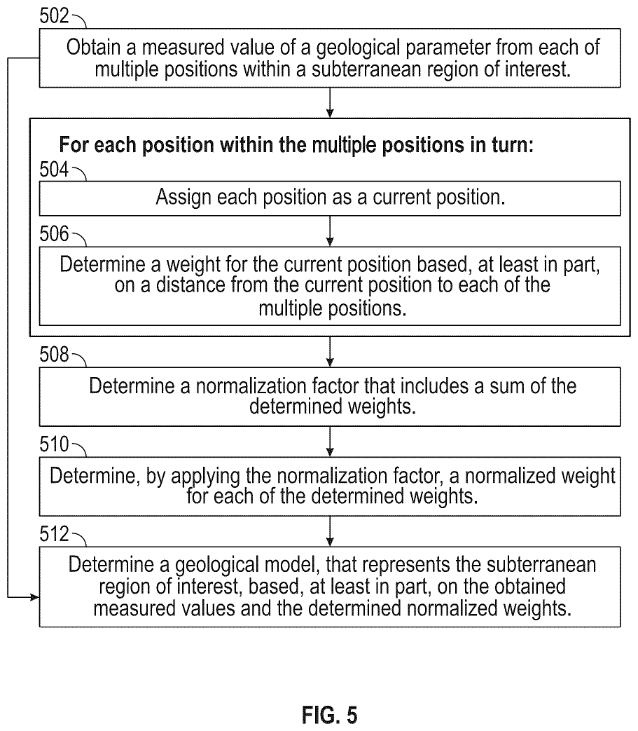

FIG. 5 describes a method in accordance with one or more embodiments. The method uses the alternative weighting scheme to determine a geological model (400). In step 502, a measured value of a geological parameter is obtained from each position (104i-r) within a subterranean region of interest (100). A measured value may be determined for a position (104i-r) using seismic data, well logs, and/or rock cores acquired at that position (104i-r) as previously described in reference to FIGS. 2 and 3. Each position (104i-r) characterized by a measured value of a geological parameter may be considered a characterized position.

Steps 504 and 506 may be performed in turn for each characterized position (104i-r) within the subterranean region of interest (100). Steps 504 and 506 may be performed in series or in parallel relative to performing these steps for a different position. In step 504, each position (104i-r) may be assigned as the current position (104p). In step 506, a weight is determined for the current position (104p). The weight may be based, at least in part, on a distance from the current position (104p) to each of the other positions (104i-r) within the subterranean region of interest (100). In some embodiments, the weight may be a sum of distances from the current position (104p) to each of the other positions (104i-r). This sum of distances may be written as:

$${\sum }_{i = 1}^{n} {d}_{i}^{p} , \qquad Equation ( 1 )$$

where n is the total number of positions (104i-r) within the subterranean region of interest (100) and dᵢ^{p} is the distance between the current position p (104p) and each of the other positions i (104i-r). Recall that distance dᵢ^{p} may be a horizontal distance between positions (104i-r), a three-dimensional distance between positions (104i-r), or a power of a distance where the exponent is a positive real number. For example, Equation (1) may then be rewritten explicitly as Σᵢ₌₁ⁿ(dᵢ^{p})^{u}, where u is the exponent.

In step 508, a normalization factor is determined. The normalization factor includes a sum of the weights previously determined in step 506, which may be written as:

$${\sum }_{p = 1}^{n} {\sum }_{i = 1}^{n} {d}_{i}^{p} . \qquad Equation ( 2 )$$

In step 510, a normalized weight is determined for each of the weights determined in step 506. A normalized weight may be determined by applying the normalization factor determined in step 508 to each of the weights determined in step 506. Assuming the embodiments described by Equations (1) and (2), a normalized weight wₚ for a current position (104p) may be written as:

$${w}_{p} = \frac{{\sum }_{i = 1}^{n} {d}_{i}^{p}}{{\sum }_{p = 1}^{n} {\sum }_{i = 1}^{n} {d}_{i}^{p}} , \qquad Equation ( 3 )$$

where each normalized weight wₚ is a ratio of each weight (Equation (1)) and the normalization factor (Equation (2)).

In step 512, a geological model (400) that represents the subterranean region of interest (100) is determined. The geological model (400) is determined based, at least in part, on the measured value of the geological parameter determined for each position (104i-r) obtained in step 502 and the normalized weight determined for each position (104i-r) in step 510. In some embodiments, a gridding algorithm may be further used to interpolate estimated values of the geological parameter between positions (104i-r). FIG. 4 shows a geological model (400) in which the alternative weighting scheme described in this disclosure is used in accordance with one or more embodiments.

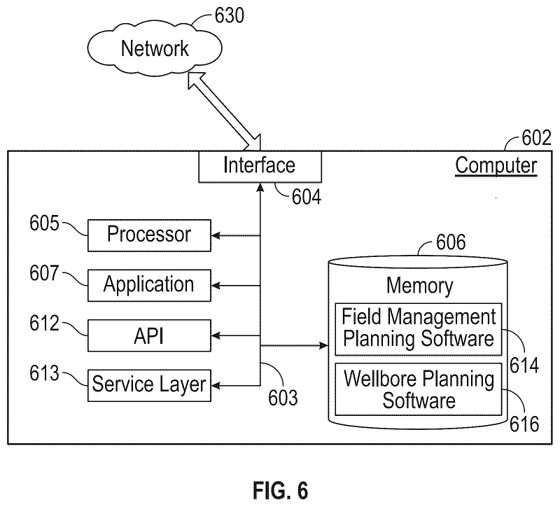

In some embodiments, a field management plan may be determined based, at least in part, on the geological model (400) determined in step 512. In some embodiments, the field management plan may include a wellbore trajectory plan. In some embodiments, field management planning software may be located on a memory of a computer to aid in determining the field management plan. In some embodiments, wellbore planning software may also be located on a memory of a computer to aid in determining the wellbore trajectory plan. In other embodiments, the wellbore planning software may be located within the field management planning software. Note that a computer will be described in reference to FIG. 6.

The field management plan may use the geological model (400) to further characterize previously identified useful features, identify additional useful features, and identify features to avoid during the drilling of a well (202) or digging of a tunnel. As such, the wellbore trajectory plan, within the field management plan, may include planning when and where to drill new wells (202) within the subterranean region of interest (100) to further penetrate previously identified useful features, penetrate additional useful features, and avoid hazardous features. The wellbore trajectory plan may further plan completion and/or stimulation strategies for wells (202).

Determining the production infrastructure, such as the size of the midstream and downstream facilities, may also be a part of the field management plan. As the subterranean region of interest (100) is further developed, the geological model (400) may be updated using the methods of this disclosure to provide further insight into the current state of the subterranean region of interest (100) such that the field management plan may be updated to ensure the subterranean region of interest (100) is being adequately managed as the state of the subterranean region of interest (100) changes.

Following determination of the field management plan, one or more field management actions may be taken based, at least in part, on the field management plan. Field management actions may include drilling and/or completing one or more new wells (202) within the subterranean region of interest (100) to penetrate previously identified valuable features and/or additionally identified useful features while avoiding hazardous features. Other field management actions may include adjusting primary, secondary, and tertiary recoveries of one or more wells to ensure production does not exceed the capacity of the midstream and/or downstream facilities. Still other field management actions may include adjusting the capacity of the midstream and/or downstream facilities to support production.

FIG. 6 depicts a block diagram of a computer system (602) used to provide computational functionalities associated with described algorithms, methods, functions, processes, flows, and procedures as described in this disclosure, according to one or more embodiments. The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or another suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols, such as the Wellsite Information Transfer Specification (WITS) protocol, associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) may store the field management planning software (614) and the wellbore planning software (616). Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing a computer (602), wherein each computer (602) communicates over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining a measured value of a geological parameter from each of a plurality of positions within a subterranean region of interest;
for each position within the plurality of positions in turn, using a computer processor:
assigning each position as a current position, and
determining a weight for the current position, based, at least in part, on a distance from the current position to each of the plurality of positions;
determining, using the computer processor, a normalization factor comprising a sum of a plurality of the determined weights;
determining, using the computer processor and by applying the normalization factor, a normalized weight for each of the plurality of the determined weights; and
determining, using the computer processor, a geological model, that represents the subterranean region of interest, based, at least in part, on a plurality of the obtained measured values and a plurality of the determined normalized weights.

2. The method of claim 1, further comprising determining a field management plan based, at least in part, on the geological model.

3. The method of claim 2, further comprising taking one or more field management actions based, at least in part, on the field management plan.

4. The method of claim 2, further comprising:
planning a wellbore trajectory within the subterranean region of interest based, at least in part, on the field management plan; and
drilling a wellbore based, at least in part, on the wellbore trajectory.

5. The method of claim 1, wherein the geological parameter comprises a seismic velocity.

6. The method of claim 1, wherein the weight comprises a sum of the distance from the current position to each of the plurality of positions.

7. The method of claim 1, wherein the distance comprises a horizontal distance.

8. The method of claim 1, wherein the normalized weight comprises a ratio of the weight and the normalization factor.

9. The method of claim 1, wherein obtaining the measured value comprises:
obtaining a rock core; and
determining the measured value from the rock core.

10. The method of claim 1, wherein the geological model comprises a seismic velocity model.

11. The method of claim 1, wherein determining the geological model comprises a gridding algorithm.

12. A non-transitory computer-readable memory comprising computer-executable instructions stored thereon that, when executed by a computer processor, cause the computer processor to perform steps comprising:
receiving a measured value of a geological parameter from each of a plurality of positions within a subterranean region of interest;
for each position within the plurality of positions in turn:
assigning each position as a current position, and
determining a weight for the current position, based, at least in part, on a distance from the current position to each of the plurality of positions;
determining a normalization factor comprising a sum of a plurality of the determined weights;
determining, by applying the normalization factor, a normalized weight for each of the plurality of the determined weights; and
determining a geological model, that represents the subterranean region of interest, based, at least in part, on a plurality of the received measured values and a plurality of the determined normalized weights.

13. The non-transitory computer-readable memory of claim 12, wherein the steps further comprise determining a field management plan based, at least in part, on the geological model.

14. The non-transitory computer-readable memory of claim 13, wherein the steps further comprise planning a wellbore trajectory within the subterranean region of interest based, at least in part, on the field management plan.

15. The non-transitory computer-readable memory of claim 12, wherein the geological parameter comprises a seismic velocity.

16. The non-transitory computer-readable memory of claim 12, wherein the weight comprises a sum of the distance from the current position to each of the plurality of positions.

17. The non-transitory computer-readable memory of claim 12, wherein the distance comprises a horizontal distance.

18. The non-transitory computer-readable memory of claim 12, wherein the normalized weight comprises a ratio of the weight and the normalization factor.

19. A system comprising:
an analysis tool configured to determine a measured value of a geological parameter from each of a plurality of positions within a subterranean region of interest; and
a computer system configured to:
receive the measured value from the analysis tool,
for each position within the plurality of positions in turn:
assign each position as a current position; and
determine a weight for the current position, based, at least in part, on a distance from the current position to each of the plurality of positions,
determine a normalization factor comprising a sum of a plurality of the determined weights,
determine, by applying the normalization factor, a normalized weight for each of the plurality of the determined weights, and
determine a geological model, that represents the subterranean region of interest, based, at least in part, on a plurality of the received measured values and a plurality of the determined normalized weights.

20. The system of claim 19, further comprising:
field management planning software configured to determine a field management plan;
wellbore planning software configured to plan a wellbore trajectory within the subterranean region of interest based, at least in part, on the field management plan; and
a drilling system configured to drill a wellbore based, at least in part, on the wellbore trajectory.
